(19) United States
(12) Patent Application Publication
(10) Pub. No.: US 2010/0206190 A1
(43) Pub. Date: Aug. 19, 2010

(54) SPRAY DAMPENER

(75) Inventors: Motoshi Aoyama, Tokyo (JP); Wataru Watanabe, Tokyo (JP)

Correspondence Address: DAY PITNEY LLP, 7 TIMES SQUARE, NEW YORK, NY, 10036-7311, US

(73) Assignee: BALDWIN-JAPAN LTD., Tokyo (JP)

(21) Appl. No.: 12/680,086

(22) PCT Filed: Sep. 26, 2008
(86) PCT No.: PCT/JP2008/067433

§ 371 Date: Mar. 25, 2010

(30) Foreign Application Priority Data
Sep. 28, 2007 (JP) 2007-256888

(51) Int. Cl. B41L 25/00

(52) U.S. Cl. 101/147

(57) ABSTRACT

It is, therefore, an object of the present invention to provide a spray dampener which prevents the foreign matter such as ink mist from being introduced into the spray dampener and prevent the dampening water in the spray dampener from being leaked outside that.

The spray dampener includes a pair of partitioned spaces. The partitioned spaces are formed along the edges. The spray dampener includes a plurality of air nozzles. The air nozzles are received in the partitioned spaces and spaced from each other longitudinally of the dampening water roller to spout compressed air toward the outer surface of the dampening water roller.

### TECHNICAL FIELD

The present invention relates to a spray type of dampening water supply device (hereinafter referred to as a spray dampener) for an offset press. In particular, the present invention relates to the spray dampener which can prevent ink mist from being dragged by a dampening water roller rotating at a high speed and introduced into the body of spray dampener to stain the spray nozzles with ink, when the ink mist is generated in the body of the press. In addition, the spray dampener can prevent dampening water mist from being leaked and scattered outwardly of the spray dampener to make a poor printed paper, when the dampening water mist exists in the spray dampener.

### BACKGROUND ART

An offset press is arranged to put ink on the image area of a printing plate, and spray dampening water to the non-image area of that for print. The press therefore includes a device for spraying dampening water, the device being called a dampener. There exist several types of dampener. A typical dampener is a spray dampener having a dampening water spray. The spray dampener has spray nozzles for spraying dampening water onto a dampening water roller.

FIG. 7 illustrates a prior spray dampener. The press includes a dampening water roller (a chromed roller) 3 which comprises a cylindrical roller having a length of about 1600 mm and rotates in a direction shown by an arrow 110. The spray dampener includes a housing 111 having a U-shaped cross section to have an opening 112 and having a length about equal to the dampening water roller 3. The housing 111 cooperates with the outer surface of the dampening water roller 3 disposed adjacent the opening 112 to form a spray chamber 115. The housing 111 has a spray nozzle mounting portion 113 on opposite side to the opening 112. A spray bar 5 shown in FIG. 1 is mounted on the spray nozzle mounting portion 113. The spray nozzles 4 mounted on the spray bar 5 includes an outlet received in the spray chamber 115 to spray dampening water toward the outer surface 114 of the dampening water roller 3 through the opening 112. The housing 111 and the spray nozzles 4 are combined with each other to constitute a spray dampener 100.

FIG. 1 illustrates the relationship between the spray of the spray dampener and the printing plate. An intermediate roller 2 is disposed between the printing plate 1 and the dampening water roller 3. The intermediate roller 2 distributes the dampening water uniformly on the dampening water roller and transfers it to the printing plate 1.

The housing 111 includes edges 116 and 117 between which the opening 112 is formed, as shown in FIG. 7. A gap 118 is formed between the edge 116 and the outer surface 114 of the dampening water roller 3, and a gap 119 is formed between the edge 117 and the outer surface 114 of the dampening water roller 3.

The prior spray damper 100 has two problems mainly. One problem relates to leakage of the dampening water from the spray chamber 115. Not all the dampening water reaches onto the dampening water roller 3 when being sprayed from the spray nozzles 4 in the spray chamber 115. Some dampening water changes into mist in the spray chamber 115 so that the mist can float in the spray chamber 115 to be leaked outwardly of the spray chamber 115 through the gap 119. The mist is put on the press and drops onto the printing plate 1 to make a poor printed paper.

The other problem relates to introduction of a foreign matter such as ink mist into the spray chamber 115. The ink mist float in the air when printing. The spray nozzles 4 are machined precisely to spray dampening water in a predetermined spray-pattern. The spray nozzles 4 cannot spray the dampening water in the correct pattern if being stained with the ink mist introduced into the spray chamber 115. The operator of the press must therefore clean or exchange the spray nozzles 4 periodically. In addition, the ink mist stains not only the spray nozzles 4 but also the inside of the spray chamber 115.

There are known prior arts intended to prevent the dampening water from being leaked from the spray chamber 115 to the outside and prevent the foreign matter from being introduced to the spray chamber 115 from the outside.

Japanese Unexamined Utility Model Application Publication No. 55-94834 discloses a dampener for making the dampening water mist by ultrasonic to put it onto the dampening water roller. The dampener includes air curtains formed on the both sides of the place where the dampening water mist puts on the dampening water roller. The air curtains prevent the mist from moving to the outside. The dampener includes means for returning residual mist to a supply source of water through an exhaust air duct. The means however cannot be applied to a high-speed press. When the dampening water roller rotates at a high speed, the dampening water mist is introduced to the outside by air which is dragged by the dampening water roller rotating at a high speed. In addition, the publication does not make reference to the introduction of the foreign matter.

The dampener includes the supply source of air for the air curtains built in the dampener. Moreover, the air curtain cannot be formed to have adequate strength throughout the entire length (about 1600 mm) of the dampening water roller.

Japanese Unexamined Patent Application Publication No. 2005-153513 discloses an art which prevents the foreign matter such as ink mist from being put onto the spray nozzles of the spray dampener. The outlets of the spray nozzles are protected by a wall not to be stained. The publication however dose not disclose an art which prevents the dampening water from being leaked from the spray dampener.

Japanese Unexamined Patent Application Publication No. 06-115057 discloses a brush-type cleaning device for the press, but it does not relate to a dampener. The device includes means for preventing a foreign matter from be leaked outside the cleaning device, when the foreign matter is removed by the brush. The device includes air curtains formed on the both sides of the brush so that the foreign matter cannot be leaked outside the device, when the foreign matter are floated by the brush. However, the publication is silent that the air curtains can be formed to have adequate strength throughout the entire length (about 1600 mm) of the dampening water roller uniformly. In addition, the publication does not make reference to the introduction of the foreign matter.

### DISCLOSURE OF THE INVENTION

### Problems to be Solved by the Invention

It is, therefore, an object of the present invention to provide a spray dampener which prevents the foreign matter such as ink mist from being introduced into the spray dampener and prevent the dampening water in the spray dampener from being leaked outside that.

### Solution to the Problems

A spray dampener includes a housing. The housing extends longitudinally of a dampening water roller. The housing has a pair of edges spaced from each other circumferentially of the dampener water roller. The housing is disposed adjacent an outer surface of the dampening water roller. An opening is formed between the edges and opposed to the outer surface of the dampening water roller. The spray dampener includes a plurality of spray nozzles. The spray nozzles are received in the housing and spaced from each other longitudinally of the dampening water roller to spray dampening water onto the outer surface of the dampening water roller. The spray dampener includes a pair of partitioned spaces. The partitioned spaces are formed along the edges, having openings opposed to the outer surface of the dampening water roller. The spray dampener includes a plurality of air nozzles. The air nozzles are received in the partitioned spaces and spaced from each other longitudinally of the dampening water roller to spout compressed air toward the outer surface of the dampening water roller. The spray dampener includes at least a pair of air supply passages. The air supply passages extend along the edges, being communicated with the air nozzles to supply the compressed air to the air nozzles.

In a preferable embodiment, the air supply passages comprise air tubes received in the partitioned spaces. The air nozzles comprise holes formed in the air tube.

The air supply passages comprise air ducts formed by members by which the partitioned spaces are formed. The air nozzles comprise holes formed in the air ducts.

Two or more air supply passages are formed along the edges. The compressed air is supplied from the air supply passages and spouted from the air nozzles.

Each of the partitioned spaces is sectioned into two or more small sections. The air nozzles are received in each of the small sections.

The air supply passages comprise common supply passages common to the small sections. The compressed air is supplied from the common supply passages and spouted from the air nozzles.

The air supply passages are formed outside the partitioned spaces. A plurality of air pipes are connected with the air supply passages, extending through walls by which the partitioned spaces are formed and reaching to the partitioned spaces. The air nozzles are formed by the air pipes.

The partitioned spaces are formed inside the housing.

The partitioned spaces are formed outside the housing.

The edges are spaced from the outer surface of the dampening water roller at a distance of 5 mm or less.

Further, the spray dampener further includes drain passages formed in the partitioned spaces for residual dampening water.

### Effect of the Invention

The present invention can prevent the ink mist from being introduced into the spray dampener through the gap between the spray dampener and the dampening water roller. Moreover, the present invention can prevent the residual dampening water mist from being leaked and scattered outside the spray dampener, when the dampening water mist exists inside the spray dampener.

The spray nozzles of the spray dampener are received in a housing. A pair of partitioned spaces is formed along a pair of edges. An opening of the housing is opposed to the outer surface of the dampening water roller. In addition, compressed air can be spouted from air nozzles inside the partitioned spaces, when the compressed air is supplied through air supply passages.

As a result, the compressed air can effectively be spouted toward the outer surface of the dampening water roller from air nozzles without being scattered. The foreign matter such as ink mist is taken away from the outer surface of the dampening water roller, and floated in the air outside the spray space before being taken into the spray space which receives the spray nozzles. As a result, the foreign matter cannot be introduced into the spray space. In addition, the dampening water mist cannot be leaked outside the spray dampener, when the dampening water mist exists inside the spray dampener.

In the preferable embodiment, the air supply passages comprise air tubes commercially available to be inexpensive. The air nozzles are formed by making holes in the air tubes. As a result, it is possible to make the air nozzles easily. In addition, it is possible to exchange the air nozzles easily when being clogged.

The air supply passages comprise air ducts formed by members by which the partitioned spaces are formed. As a result, the air supply passages can have any shaped cross section and have a high structural stability when being mass produced.

Two or more air supply passages are formed along the edges. As a result, the air supply passages can have decreased air resistance so that more compressed air can be spouted.

The partitioned spaces are sectioned into two or more small sections, to be complex a little in structure. However it is possible to enhance the effects of the partitioned spaces and the air nozzles.

The air supply passages comprise common supply passages common to the small sections. The compressed air is supplied through the common supply passages and spouted from the air nozzles, to make simple in structure when the partitioned spaces are sectioned into two or more small sections.

The air supply passages are formed outside the partitioned spaces. A plurality of air pipes is connected with the air supply passages, extending through walls by which the partitioned spaces are formed and reaching to the partitioned spaces. The air nozzles are formed by the air pipes to make the spray dampener mounted more easily.

The partitioned spaces are formed inside the housing, so that the spray dampener can be the same as a prior spray dampener in outer shape to be compatible with a prior spray dampener. Accordingly, the spray dampener can be easily exchanged for a prior spray dampener.

The partitioned spaces are formed outside the housing, to widen the opening area of the spray chamber inside the housing.

The edges are spaced from the outer surface of the dampening water roller at a distance of 5 mm or less, to prevent the introduction of the ink and the leakage of the dampening water.

The drain passages are formed in the partitioned spaces for residual dampening water, not to disturb the air flow of the air nozzles by the residual dampening water when the dampening water is liquefied inside the partitioned spaces.

### BRIEF DESCRIPTION OF THE DRAWINGS

FIG. 1 is a schematic view illustrating the spray dampener built in the offset press according to the invention.

FIG. 2. is a perspective view illustrating an embodiment of the present invention.

FIG. 3. is a cross-sectional view illustrating the spray dampener in FIG. 2 along the line I-I.

FIG. 4. is an enlarged view illustrating a partitioned space in FIG. 3.

FIG. 5. is a cross-sectional view illustrating another embodiment of the present invention.

FIG. 6. is a cross-sectional view illustrating another embodiment of the present invention.

FIG. 7. is a schematic view illustrating a prior spray dampener.

FIG. 8. is a cross-sectional view illustrating another embodiment of the present invention.

FIG. 9. is an explanatory drawing illustrating another embodiment of the present invention.

FIG. 10. is a cross-sectional view illustrating another embodiment of the present invention.

FIG. 11. is a cross-sectional view illustrating another embodiment of the present invention.

### DESCRIPTION OF THE REFERENCE CHARACTERS

3 dampening water roller

4 spray nozzle

60A, 60B partitioned space

71A, 71B air supply passage

72 air nozzle

100 spray dampener

111 housing

114 outer surface

116, 117, 543, 544 edge

### BEST MODE FOR CARRYING OUT THE INVENTION

Hereinafter, some embodiments of the present invention will be described in detail.

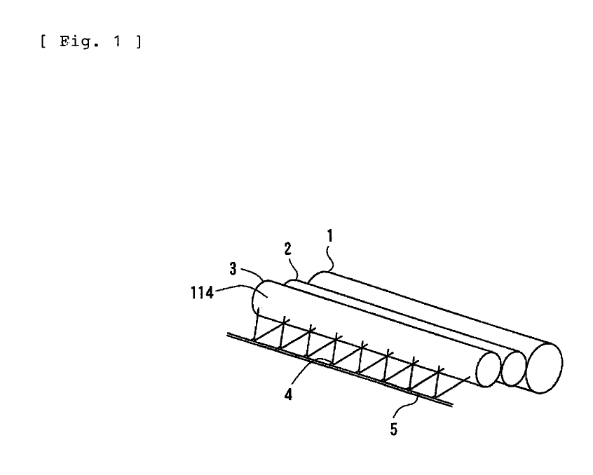

Turning to the drawing, FIG. 1 illustrates a spray dampener used in an offset press according to the invention. The press includes a plate cylinder 1. Dampening water must be supplied onto the plate cylinder 1 finally. The press includes a dampening water roller 3 and an intermediate roller 2. The plate cylinder 1 and the intermediate roller 2 rotate at a high speed according to the printing speed of the press. The press includes spray nozzles 4 for spraying the dampening water. The press includes a spray bar 5 for supporting the spray nozzles 4. The plate cylinder 1, the intermediate roller 2 and the dampening water roller 3 have a length according to the width of the printing paper, the length is about 1600 mm in the case of the press for printing newspaper. A plurality of the spray nozzles 4 are disposed in a horizontal line, which spray the dampening water onto the outer surface 114 of the dampening water roller 3 uniformly.

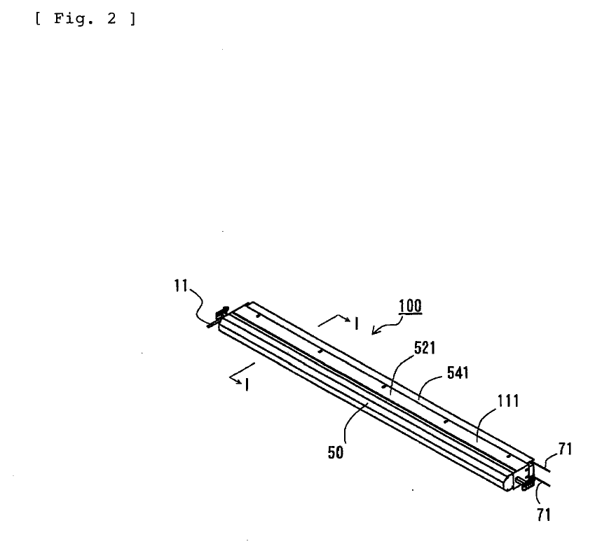

FIG. 2 illustrates the spray dampener which prevents mist from being scattered and staining. The spray dampener 100 includes two parts. One comprises a spray bar body portion 50 and a plate 521, while the other comprises a cover portion 541. The spray bar body portion 50, the plate 521 and the cover portion 541 can be separated respectively for maintenance. The spray bar body portion 50 is provided with the spray bar 5 and the spray nozzles 4 as shown in FIG. 1. The cover 541 cooperates with the spray bar body portion 50 and the plate 521 to form a housing 111.

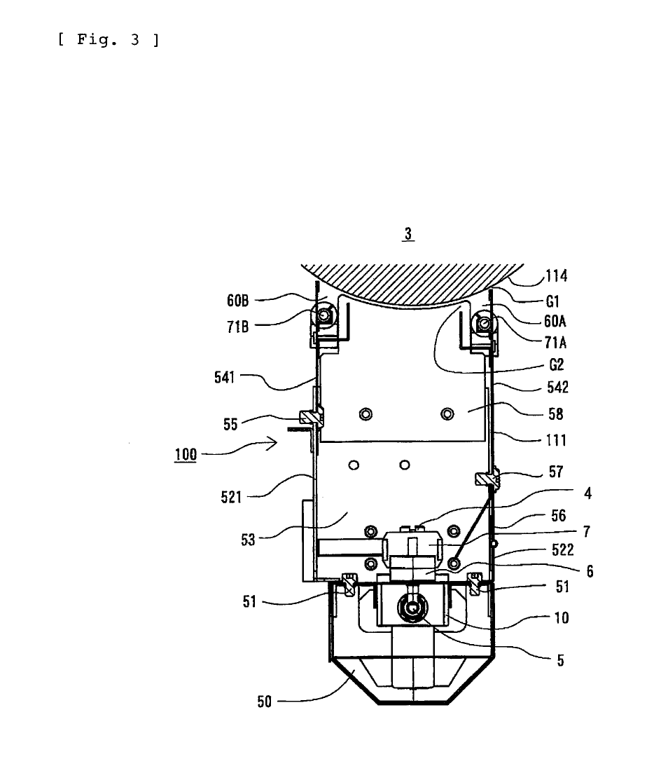

FIG. 3. is a cross-sectional view illustrating the spray dampener 100 in FIG. 2 along the line I-I.

The dampening water roller 3 rotates in a clockwise direction in FIG. 3. The spray bar body portion 50 is opposed to the dampening water roller 3. The plates 521 and 522 are mounted on the both sides of the spray bar body portion 50. The cover portions 541 and 542 are mounted on the plates 521 and 522 respectively. The cover portions 541 and 542, the plates 521 and 522, and the spray bar body portion 50 cooperate with each other to form the housing 111. An end cover 58 and an end plate 53 are disposed on the both ends of the housing 111, which can cover the both ends of the housing 111.

The housing 111 has an opening 112 which be opposed to the outer surface 114 of the dampening water roller 3.

A spray dampener assembly 10 is received in the spray bar body portion 50. The spray bar 5 is mounted on the spray dampener assembly 10. The spray bar 5 is connected to a water supply pipe 11 shown in FIG. 2. Nozzle nuts 7 are mounted on the spray bar 5 via a nozzle base portion 6. The spray nozzles 4 are built in the nozzle nuts 7. The dampening water is supplied through the water supply pipe 11 to be sprayed from the spray nozzles 4. The spray bar body portion 50 and the plates 521, 522 are connected with each other by screws 51. Screws 55 connect the cover 541 with the plate 521, while screws 57 connect the cover 542 with the plate 522. A hinge 56 allows the opening and closing of the cover 542 on the plate 522.

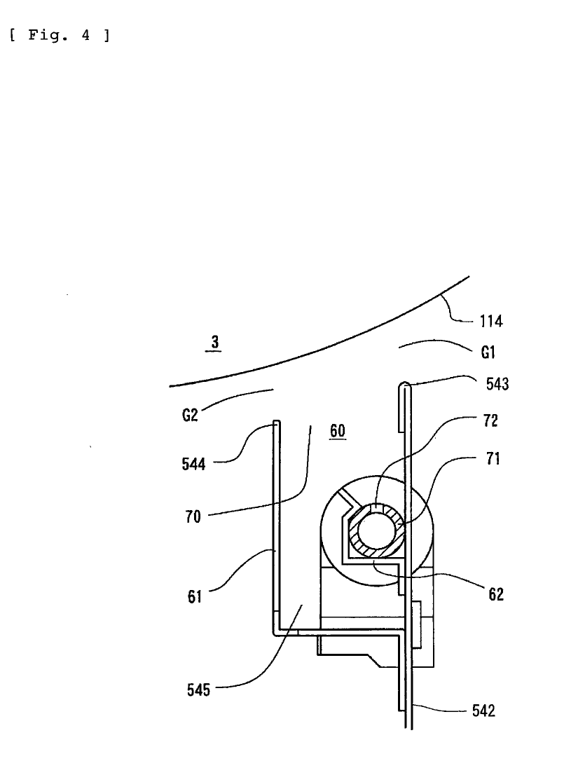

As shown in FIG. 3, the apparatus includes the first partitioned space 60A, the second partitioned space 60B, the first air supply passage 71A, and the second air supply passage 71B. FIG. 4 is an enlarged view illustrating a portion around the first partitioned space 60A. The first partitioned space 60A and the second partitioned space 60B may be symmetry. Therefore one of them is merely described hereinafter in detail. The other may be omitted.

As shown in FIG. 4, a wall member 61 is a L-shaped in cross-sectional view. The wall member 61 and the cover 542 cooperate with each other to form the partitioned spaces 60 having an opening 70. The air supply passage 71 comprises an air tube. As shown in FIG. 2, one end of the air tube 71 is disposed outside the housing 111. The other end thereof is closed inside the housing 111. Compressed air is supplied through the air tube 71. A tube fixing bracket 62 fixes the air tube 71 on the cover 542. The air tube 71 can comprise a synthetic resin air tube which is commercially available. A plurality of holes are formed in the air tube 71 by a drill to be made as compressed air nozzles 72.

A drain passage 545 is formed in the partitioned spaces 60. Some mist is introduced into the partitioned spaces 60, when the mist is formed by spraying the dampening water from the spray nozzles 4. The mist changes into drop to put on the wall member 61, when the mist is introduced into the partitioned spaces 60. The drop of dampening water may close the compressed air nozzles 72. In this case, the dampening water is drained through the drain passage 545. The dampening water is drained out the spray dampener 100 with another residual dampening water existed in the housing 111, when the dampening water is gathered by the drain passage 545.

The edge 543 of the cover 542 may preferably be spaced from the outer surface 114 of the dampening water roller 3 at a distance G1 of 5 mm or less, or preferably 4 mm or less. The edge 544 of the wall member 61 may be preferably spaced from the outer surface 114 of the dampening water roller 3 at a distance G2 of 5 mm or less, or preferably 4 mm or less.

With regard to the structure in FIGS. 3 and 4, experiments are performed on the ink mist which is introduced into the housing 111 from the outside. The synthetic resin air tube is used as the air tube 71, which is commercially available and has an outer diameter of 6 mm and an inner diameter of 4 mm. The air nozzles 72 are formed by making a plurality of holes having a diameter of 0.2 mm, and equally spaced from each other at intervals of 5 mm. The pressure of air is changed into 0.15 Mpa, 0.20 Mpa and 0.25 Mpa, in which the air is supplied to the air tube 71. When the spray dampener 100 is mounted on the press, and some white papers having a 20 mm square are put on the spray nozzles 4, the adhesion of the ink is evaluated under eye observation.

When being evaluated under a change of the air pressure and a change of distances G1 and G2 into 6 mm, 5 mm, 4 mm and 3 mm, the adhesion of the ink is hardly generated on the papers under the distances of 4 mm or less. Under the distances of 5 mm, the adhesion of the ink is generated a little. Under the distances of 6 mm, the adhesion of the ink is increased clearly. The same evaluations are obtained under a change of the air pressure. It is therefore confirmed that the change of the air pressure does not have an influence. In the case of non-supply air, the adhesion of the ink is generated clearly regardless of the distances.

In addition, the leakage of the dampening water mist can be recognized by the amount of the residual dampening water. The effect of the present invention is confirmed.

Hereinafter, another embodiments of the present invention will be described. The air tube 71 shown in FIG. 4 can be made of resin or metal. Each of the distances G1 and G2 shown in FIG. 4 may be same as or different from each other. Each element of the present invention can be symmetry, same or different in structure, size or air pressure, when the each element is, for example, the first and second partitioned spaces 60A and 60B, or the air supply passages 71A and 71B.

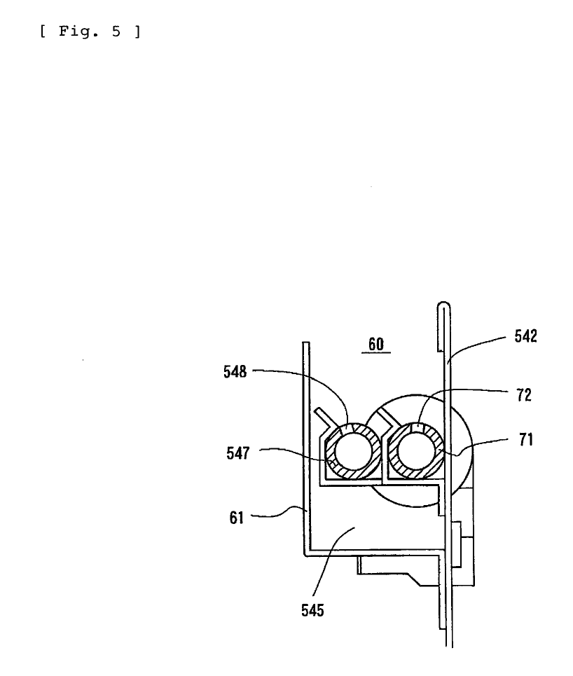

As shown in FIG. 5, not only the air supply passage 71 shown in FIG. 3 but also an air supply passage 547 are mounted to form two rows. Air nozzles 548 similar to the air nozzles 72 are formed in the air supply passage 547. The air supply passages can increase the cross-section area by forming two rows to have decreased air resistance. The air supply passages have a length of about 1600 mm according to the length of the spray dampener 100. In this case, it is preferable that the air is spouted uniformly from the air nozzles 72 and 548 throughout the total length thereof. The air supply passages form two rows so that the number of the air nozzles can be decreased by half per one row. As a result, the air can be spouted uniformly more than one row.

The partitioned spaces 60 shown in FIGS. 3 and 4 are formed inside the housing 111. The offset press may not have an adequate space for mounting the spray dampener 100. The spray dampener 100 can be exchanged for a prior spray dampener when being the same as a prior spray dampener in size. When the partitioned spaces 60 are formed inside the housing 111, the spray dampener 100 can be the same as a prior spray dampener in size. As a result, the spray dampener 100 is highly interchangeable with a prior press.

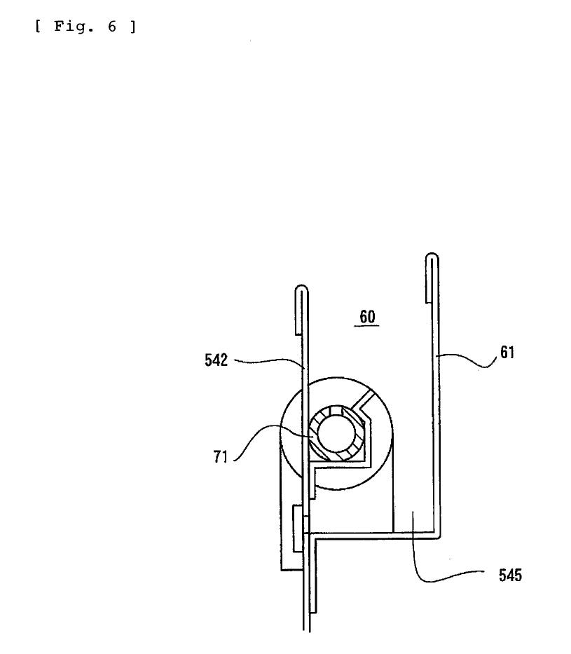

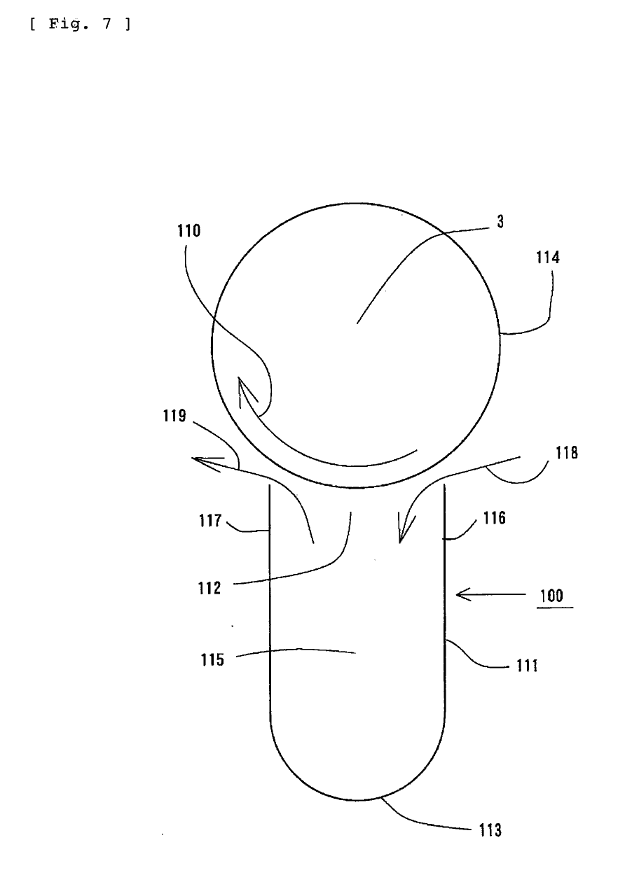

As shown in FIG. 6, the partitioned spaces 60 are formed outside the cover 542 of the housing 111. In the case that there is room around the spray dampener 100 mounted on a prior press, it is sometimes preferable that the partitioned spaces 60 are formed outside the housing 111, because the area of the opening 112 is decreased if the partitioned spaces 60 are formed inside the opening 112, as shown in FIG. 7. It is not required to take into account a change of the area of the opening 112 when the partitioned spaces 60 can be formed outside the housing 111.

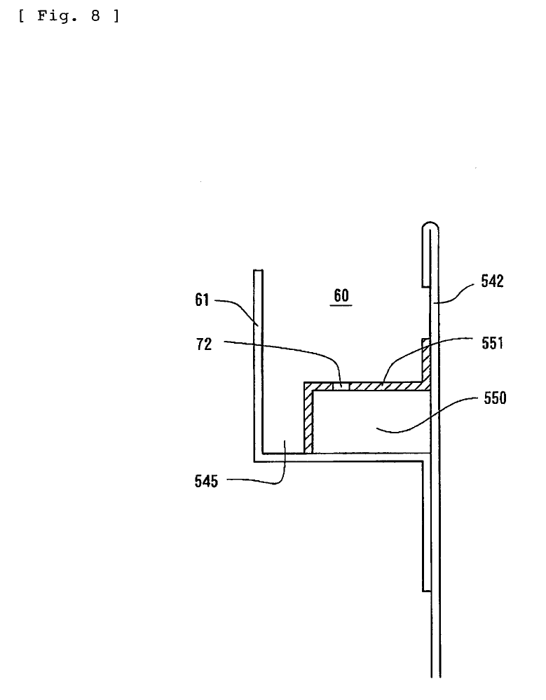

As shown in FIG. 8, air ducts 550 are formed as the air supply passages 71 shown in FIG. 4. A duct sheet metal 551 has a L-shaped cross section. The air duct 550 is formed into a rectangle by the wall member 61, the cover 542 and the duct sheet metal 551. The air nozzles 72 are provided in the duct sheet metal 551, and spaced from each other at equal intervals. The cross-section area of the air duct 550 can be larger than that of the air tube 71, when the partitioned space 60 is the same as that shown in FIG. 4.

The air duct 550 can have any cross-section shapes, for example a triangle, a pentagon and so on. In addition, the air duct 550 can be disposed at any places inside the partitioned space 60 when being cooperated with the member of the partitioned space 60.

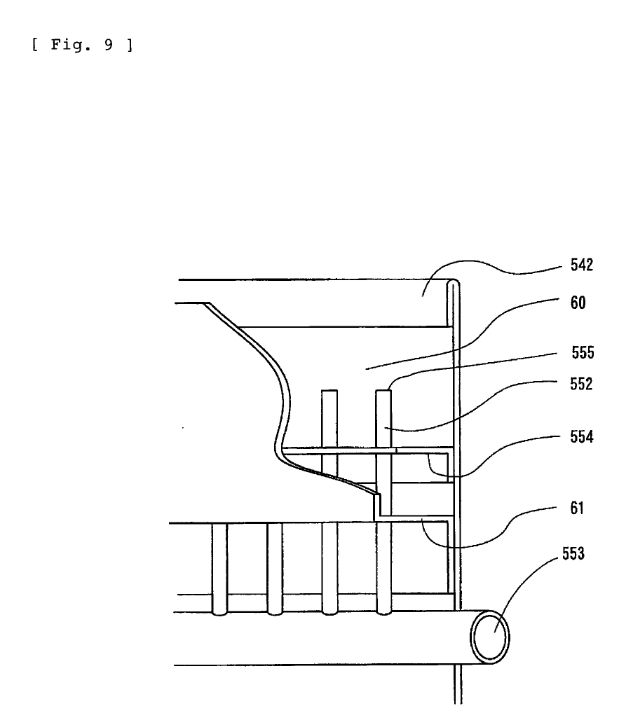

FIG. 9 illustrates another embodiment. As shown in FIG. 9, air nozzles 552 are mounted inside the partitioned space 60, while an air supply passage (air duct) 553 is mounted away from the partitioned space 60. The ends of the air nozzles 552 are received in the partitioned space 60. The air nozzles 552 comprise air pipes. The air pipes are connected to the air supply passage 553, passing through the wall member 61 and a supporting member 554 to reach into the partitioned space 60. As a result, the partitioned space 60 can be spaced away from the air supply passage 553. Although not shown, the air supply passage 553 can be disposed outside the housing 111 when the air nozzles 552 passes through the cover 542.

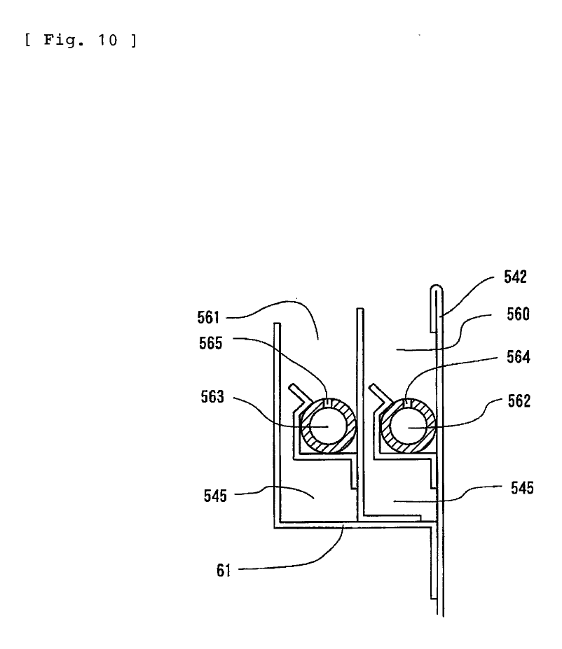

FIG. 10 illustrates another embodiment. As shown in FIG. 10, the partitioned space 60 shown in FIG. 4 is sectioned into two small sections 560 and 561. Air supply passage ducts 562, 563 and air nozzles 564, 565 are provided inside the small sections 560 and 561. As a result, it is possible to enhance the effects of the partitioned spaces and the air nozzles by sectioning into a plurality of small sections. Although not shown, the partitioned space 60 can be sectioned into three or more small sections.

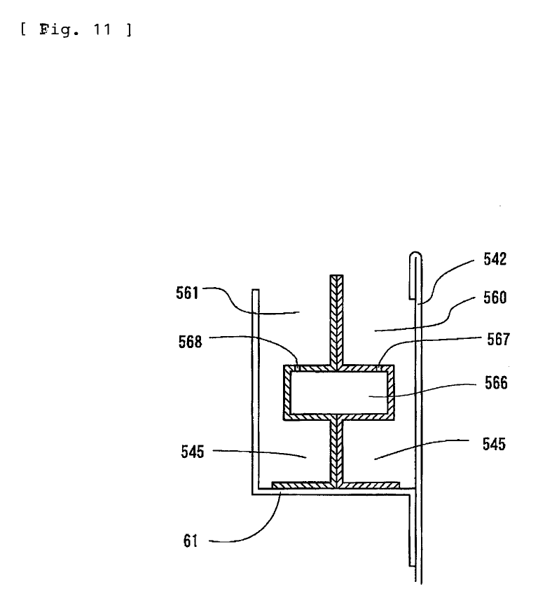

FIG. 11 illustrates another embodiment. As shown in FIG. 11, the partitioned space 60 shown in FIG. 4 is sectioned into two small sections 560 and 561. One air supply passage 566 is formed between the small sections 560 and 561. The air supply passage 566 is provided with the air nozzles 567 for the small section 560 and the air nozzles 568 for the small section 561. Although not shown, the partitioned space 60 can be sectioned into three or more small sections.

1. A spray dampener comprising:
a housing extending longitudinally of a dampening water roller, and having a pair of edges spaced from each other circumferentially of the dampener water roller and disposed adjacent an outer surface of the dampening water roller, an opening being formed between the edges and opposed to the outer surface of the dampening water roller;
a plurality of spray nozzles received in the housing and spaced from each other longitudinally of the dampening water roller to spray dampening water onto the outer surface of the dampening water roller;
a pair of partitioned spaces formed along the edges and having openings opposed to the outer surface of the dampening water roller;
a plurality of air nozzles received in the partitioned spaces and spaced from each other longitudinally of the dampening water roller to spout compressed air toward the outer surface of the dampening water roller; and
at least a pair of air supply passages extending along the edges and communicated with the air nozzles to supply the compressed air to the air nozzles.

2. The spray dampener according to claim 1,
wherein the air supply passages comprise air tubes received in the partitioned spaces, the air nozzles comprising holes formed in the air tube.

3. The spray dampener according to claim 1,
wherein the air supply passages comprise air ducts formed by members by which the partitioned spaces are formed, the air nozzles comprising holes formed in the air ducts.

4. The spray dampener according to claim 1, further comprising
two or more air supply passages formed along the edges, the compressed air being supplied from the air supply passages and spouted from the air nozzles respectively.

5. The spray dampener according to claim 1,
wherein each of the partitioned spaces is sectioned into two or more small sections, the air nozzles being received in each of the small sections respectively.

6. The spray dampener according to claim 5,
wherein the air supply passages comprise common supply passages common to the small sections, the compressed air being supplied from the common supply passages and spouted from the air nozzles.

7. The spray dampener according to claim 1,
wherein the air supply passages are formed outside the partitioned spaces, a plurality of air pipes being connected with the air supply passages, extending through walls by which the partitioned spaces are formed and reaching to the partitioned spaces, the air nozzles being formed by the air pipes.

8. The spray dampener according to claim 1,
wherein the partitioned spaces are formed inside the housing.

9. The spray dampener according to claim 1,
wherein the partitioned spaces are formed outside the housing.

10. The spray dampener according to claim 1,
wherein the edges are spaced from the outer surface of the dampening water roller at a distance of 5 mm or less.

11. The spray dampener according to claim 1, further comprising
drain passages formed in the partitioned spaces for residual dampening water.
